(19) United States
(12) Patent Application Publication
(10) Pub. No.: US 2013/0114115 A1
(43) Pub. Date: May 9, 2013

(54) CONTACT IMAGE SENSOR AND RECOGNITION SYSTEM AND METHOD THEREOF

(71) Applicant: Ching-Yuan Chou, New Taipei City (TW)

(72) Inventor: Ching-Yuan Chou, New Taipei City (TW)

(73) Assignees: Kinpo Electronics, Inc., New Taipei City (TW); Cal-Comp Electronics & Communications Company Limited, New Taipei City (TW)

(21) Appl. No.: 13/552,661

(22) Filed: Jul. 19, 2012

(30) Foreign Application Priority Data
Nov. 9, 2011 (TW) 100140887

(51) Int. Cl. H04N 1/04; H04N 1/40

(52) U.S. Cl. 358/444; 358/482; 358/475; 358/445

(57) ABSTRACT

A contact image sensor (CIS) and a recognition system and a recognition method thereof are provided. A storage unit storing driving information of the CIS is directly built in the CIS, and a control module of the CIS is enabled to actively transmit/report the driving information of the CIS back to a check terminal in response to a recognition demand, so that the check terminal recognizes a product specification of the CIS. Hence, the CIS may be further effectively recognized.

### CROSS-REFERENCE TO RELATED APPLICATION

This application claims the priority benefit of Taiwan application serial no. 100140887, filed on Nov. 9, 2011. The entirety of the above-mentioned patent application is hereby incorporated by reference herein and made a part of this specification.

### BACKGROUND OF THE INVENTION

1. Field of the Invention

The present invention generally relates to a recognition technology, in particular, to a recognition system and a recognition method relating to a contact image sensor (CIS).

2. Description of Related Art

A common scanning device is usually configured to scan and convert document data or an object having text, pictures, graphics, and drawings to a digital electronic file, and store the digital electronic file in a computer, so that the computer may further perform digital processing actions, for example, digital display, edition, storage, and output on the stored digital electronic file.

Main light sensors used in the existing scanning device may be approximately divided into two types, one is a charge couple device (CCD), and the other is a CIS. For example, for the scanning device using the CCD, a scanning speed of the CCD is relatively quick, and it is a common method recently, but the disadvantage is that a relatively complex optical system is required, so that an entire volume of the scanning device may not be reduced.

In addition, for the scanning device using the CIS, the feature is that for example, a scan light source, a lens, and other components are integrated in the CIS, so that the entire structure, the principle, and the light paths are relatively simple, in this manner, the entire volume of the scanning device may be designed to be thinner and smaller. Accordingly, design features of the CIS in structure accord with a developing direction of future electronic products, so that the manner of adopting the CIS as the light sensor of the scanning device will increasingly become popular.

Generally, specifications, driving manners, and characteristics of the CISs manufactured by different manufacturers are different. Therefore, if the CIS is driven by adopting an inappropriate driving manner, the driven CIS cannot have the original functions to capture an image of an object to the scanned.

A conventional recognition method of the CIS is that a driving manner is randomly given, so as to drive the CIS, and then it is determined whether a scanning image corresponding to the object to be scanned is output. Once the scanning image corresponding to the object to be scanned is output, the given driving manner is appropriate, so as to recognize a product specification of the CIS.

However, if the scanning image corresponding to the object to be scanned is not output, that is, a blank scanning image is output, the given driving manner is inappropriate. In this manner, it is necessary to randomly give another driving manner to drive the CIS, until the scanning image corresponding to the object to be scanned is output.

It may be known that the conventional recognition method of the CIS can recognize the CIS with a complete hardware scanning mechanism and circuit. Further, the conventional recognition process of the CIS needs to pass through an actual scanning procedure, and needs to randomly give undetermined driving manners to recognize the CIS. Obviously, the conventional recognition method of the CIS is quite ineffective and time-costing.

### SUMMARY OF THE INVENTION

Accordingly, the present invention is directed to a CIS, a recognition system, and a recognition method thereof, so as to further effectively recognize the CIS.

An exemplary embodiment of the present invention provides a recognition system, which includes a CIS and a check terminal, in which the CIS includes a control module and a storage unit. The control module is configured to be served as an operation core of the CIS. The storage unit is coupled to the control module, and configured to store driving information relating to the CIS. The check terminal is coupled to the control module, and configured to transmit a trigger signal to the control module in response to a recognition demand. In this manner, the control module accesses the storage unit in response to the trigger signal, and transmits the driving information of the CIS back to the check terminal, so that the check terminal recognizes a product specification of the CIS.

Another exemplary embodiment of the present invention provides a CIS, which includes a control module and a storage unit. The control module is configured to be served as an operation core of the CIS. The storage unit is coupled to the control module, and configured to store driving information relating to the CIS. The control module accesses the storage unit in response to a recognition demand, and transmits the driving information of the CIS back to a check terminal, so that the check terminal recognizes a product specification of the CIS.

Further another exemplary embodiment of the present invention provides a recognition method of a CIS, which includes: building a storage unit storing driving information of the CIS in the CIS; and enabling a control module of the CIS to access the storage unit in response to a recognition demand, and transmit the driving information of the CIS back to a check terminal, so that the check terminal recognizes a product specification of the CIS.

In an exemplary embodiment of the present invention, the stored driving information includes a driving manner of the CIS, and the driving manner may include at least a control command and an operation timing of the CIS.

In an exemplary embodiment of the present invention, the product specification of the CIS at least includes a hardware model and a version of the CIS.

In view of the above mentioned, in the present invention, a storage unit storing driving information of a CIS is directly built in the CIS, and a control module of the CIS is enabled to actively transmit/report the driving information of the CIS back to a check terminal in response to a recognition demand, so that the check terminal recognizes a product specification of the CIS. Hence, in the present invention, the CIS may be further effectively recognized.

It should be understood that the above description and the description of embodiments in the following are only exemplary and illustrative, instead of limiting the scope of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a recognition system 10 according to an exemplary embodiment of the present invention.

FIG. 2 is a flow chart of a recognition method of a CIS according to an exemplary embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

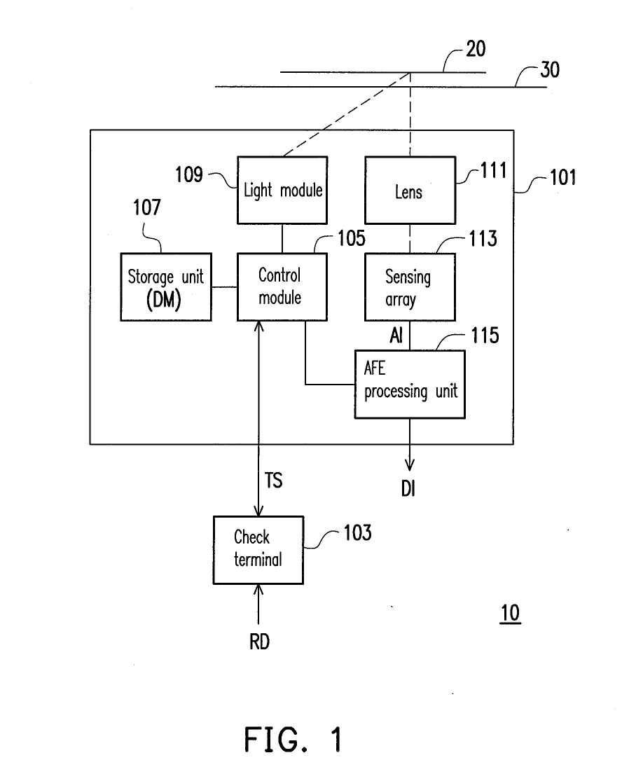

FIG. 1 is a schematic view of a recognition system 10 according to an exemplary embodiment of the present invention. Referring to FIG. 1, the recognition system 10 of this exemplary embodiment includes a contact image sensor (CIS) 101 and a check terminal 103. The CIS 101 includes a control module 105, a storage unit 107, a light module 109, a lens 111, a sensing array 113, and an analog front-end (AFE) processing unit 115.

In this exemplary embodiment, the control module 105 is configured to be served as an operation core of the CIS 101.

The storage unit 107 is coupled to the control module 105, and configured to store driving information relating to the CIS 101, for example, a driving manner DM of the CIS, which may include control command(s) and an operation timing of the CIS, but the present invention is not limited thereto.

The light module 109 is coupled to and controlled by the control module 105, and configured to provide a light source required to irradiate an object to be scanned 20 placed on a transparent platform 30, in which the light source may be a monochromatic or color light source (for example, red-green-blue light source, but the present invention is not limited thereto).

The lens 111 is configured to focus the reflecting light source irradiating the object to be scanned 20, so as to generate a focused light source relating to the object to be scanned 20.

The sensing array 113 is coupled to and controlled by the control module 113. The sensing array 113 has a plurality of sensing chips (not shown) arranged in an array, in which the sensing chips may adopt a CCD or complementary metal oxide semiconductor (CMOS) sensing technology, and each sensing chip further has a plurality of sensing basic cells. In this manner, the sensing array 113 may generate an analog image message AI corresponding to the object to be scanned 20 in response to the focused light source generated by the lens 111.

The AFE processing unit 115 is coupled to and controlled by the control module 105, and configured to convert the analog image message AI generated by the sensing array 113, so as to generate a digital image message DI corresponding to the object to be scanned 20 for a subsequent system processing terminal (not shown). In brief, a main function of the AFE processing unit 115 is to be served as an analog to digital (A/D) converter. Obviously, in other exemplary embodiments of the present invention, the AFE processing unit 115 may be an optional component, and may also be disposed on a system processing terminal out of the CIS 101.

On the other hand, the check terminal 103 is coupled to the control module 105, and configured to transmit a trigger signal TS to the control module 105 in response to a recognition demand RD. In this manner, the control module 105 accesses the storage unit 107 in response to the trigger signal TS from the check terminal 103, and (actively) transmits/reports the driving information of the CIS 101 back to the check terminal 103, so that the check terminal 103 may recognize a product specification of the CIS 101, for example, a hardware model and a version of the CIS 101, but the present invention is not limited thereto.

It may be known that the recognition system 10 of this exemplary embodiment may recognize the CIS 101 without a complete hardware scanning mechanism and circuit. Further, when recognizing the CIS 101, the check terminal 103 only needs to transmit the trigger signal TS to the control module 105 in response to the recognition demand RD, and actively knows the product specification (the hardware model and the version) of the CIS 101, without recognizing the product specification of the CIS 10 by using a try in error method and an actual scanning procedure in the prior art. Obviously, compared with the conventional recognition method of the CIS, the recognition system 10 of this exemplary embodiment may further effectively recognize the CIS 101, thereby greatly reducing time of recognizing the CIS 101.

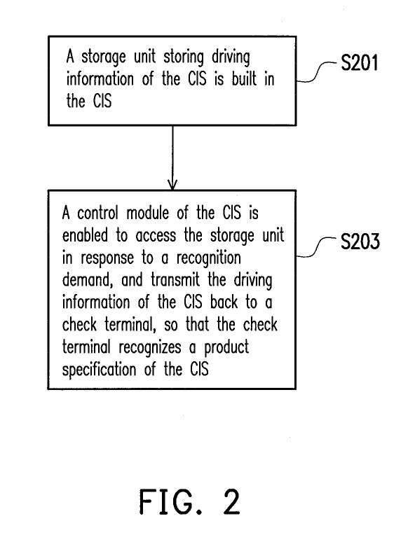

Based on the content disclosed/taught in the above exemplary embodiment, FIG. 2 is a flow chart of a recognition method of a CIS according to an exemplary embodiment of the present invention. Referring to FIG. 2, the recognition method of the CIS of this exemplary embodiment includes the following steps.

A storage unit storing driving information of the CIS is built in the CIS (Step S201).

A control module of the CIS is enabled to access the storage unit in response to a recognition demand, and transmit the driving information of the CIS back to a check terminal, so that the check terminal recognizes a product specification of the CIS (Step S203).

In this exemplary embodiment, the stored driving information of the CIS may include a driving manner of the CIS, which includes control command(s) and an operation timing of the CIS, but the present invention is not limited thereto. In addition, the product specification of the CIS at least includes a hardware model and a version of the CIS, but the present invention is not limited thereto.

To sum up, in the present invention, a storage unit storing driving information of a CIS is directly built in the CIS, and a control module of the CIS is enabled to actively transmit/report the driving information of the CIS back to a check terminal in response to a recognition demand, so that the check terminal recognizes a product specification of the CIS. Hence, in the present invention, the CIS may be further effectively recognized.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. In addition, any embodiment or claim of the present invention needs not to achieve all the objectives, advantages, or features of the present invention. Moreover, the abstract and the title are only used to facilitate searching of the patent documents, without limiting the scope of the present invention.

What is claimed is:

1. A recognition system, comprising:
a contact image sensor (CIS), comprising:
a control module, configured to be served as an operation core of the CIS; and
a storage unit, coupled to the control module, and configured to store driving information relating to the CIS; and
a check terminal, coupled to the control module, and configured to transmit a trigger signal to the control module in response to a recognition demand,
wherein the control module accesses the storage unit in response to the trigger signal, and transmits the driving information of the CIS back to the check terminal, so that the check terminal recognizes a product specification of the CIS.

2. The recognition system according to claim 1, wherein the CIS further comprises:
a light module, coupled to and controlled by the control module, and configured to provide a light source required to irradiate an object to be scanned;
a lens, configured to focus a reflecting light source irradiating the object to be scanned, so as to generate a focused light source relating to the object to be scanned; and
a sensing array, coupled to and controlled by the control module, and configured to generate an analog image message corresponding to the object to be scanned in response to the focused light source.

3. The recognition system according to claim 2, wherein the CIS further comprises:
an analog front-end (AFE) processing unit, coupled to and controlled by the control module, and configured to convert the analog image message, so as to generate a digital image message corresponding to the object to be scanned.

4. The recognition system according to claim 1, wherein the driving information comprises a driving manner of the CIS.

5. The recognition system according to claim 4, wherein the driving manner comprises at least a control command and an operation timing of the CIS.

6. The recognition system according to claim 1, wherein the product specification at least comprises a hardware model and a version of the CIS.

7. A contact image sensor (CIS), comprising:
a control module, used to be served as an operation core of the CIS; and
a storage unit, coupled to the control module, and configured to store driving information relating to the CIS,
wherein the control module accesses the storage unit in response to a recognition demand, and transmits the driving information of the CIS back to a check terminal, so that the check terminal recognizes a product specification of the CIS.

8. The CIS according to claim 7, further comprising:
a light module, coupled to and controlled by the control module, and configured to provide a light source required to irradiate an object to be scanned;
a lens, configured to focus a reflecting light source irradiating the object to be scanned, so as to generate a focused light source relating to the object to be scanned; and
a sensing array, coupled to and controlled by the control module, and configured to generate an analog image message corresponding to the object to be scanned in response to the focused light source.

9. The CIS according to claim 8, further comprising:
an analog front-end (AFE) processing unit, coupled to and controlled by the control module, and configured to convert the analog image message, so as to generate a digital image message corresponding to the object to be scanned.

10. The CIS according to claim 7, wherein the driving information comprises a driving manner of the CIS.

11. The CIS according to claim 10, wherein the driving manner comprises at least a control command and an operation timing of the CIS.

12. The CIS according to claim 7, wherein the product specification at least comprises a hardware model and a version of the CIS.

13. A recognition method of a contact image sensor (CIS), comprising:
building a storage unit storing driving information of the CIS in the CIS; and
enabling a control module of the CIS to access the storage unit in response to a recognition demand, and transmit the driving information of the CIS back to a check terminal, so that the check terminal recognizes a product specification of the CIS.

14. The recognition method of the CIS according to claim 13, wherein the driving information comprises a driving manner of the CIS.

15. The recognition method of the CIS according to claim 14, wherein the driving manner comprises at least a control command and an operation timing of the CIS.

16. The recognition method of the CIS according to claim 13, wherein the product specification at least comprises a hardware model and a version of the CIS.
